(19) United States
(12) Patent Application Publication
(10) Pub. No.: US 2017/0129290 A1
(43) Pub. Date: May 11, 2017

(54) TIRE

(71) Applicant: BRIDGESTONE CORPORATION, Tokyo (JP)

(72) Inventor: Kei TSUCHIYA, Hachioji-shi (JP)

(73) Assignee: BRIDGESTONE CORPORATION, Tokyo (JP)

(21) Appl. No.: 15/317,787

(22) PCT Filed: Jun. 4, 2015
(86) PCT No.: PCT/JP2015/066168

§ 371 Date: Dec. 9, 2016

(30) Foreign Application Priority Data
Jun. 13, 2014 (JP) 2014-122554

(51) Int. Cl. B60C 15/06; B60C 15/024

(52) U.S. Cl. CPC B60C 15/06; B60C 15/024; B60C 2015/0614

(57) ABSTRACT

A pneumatic tire includes a bead part having a bead core, and a carcass layer folded around the bead core in the bead part. The bead part includes a bead inner-face part defined as a region at an inner side of the carcass layer in a tire width direction and at an outer side of a bead toe in a tire radial direction, a bead base part defined as a region at an inner side of the carcass layer in the tire radial direction and at an outer side of the bead toe in the tire width direction, and a high-hardness rubber layer having hardness higher than hardness of the bead base part and provided in at least a part of the bead inner-face part.

### TECHNICAL FIELD

The present invention relates to a tire.

### BACKGROUND ART

Conventionally, various techniques to improve durability performance with respect to a bead unseating in which a bead part is slipped off from a rim by lateral force applied to a sidewall part of a tire, namely rim slip-off resistance is proposed (see Patent Literature 1).

A tire according to Patent Literature 1 has a pair of right and left bead parts, sidewall parts extended from the bead parts respectively toward an outer side in a tire radial direction, and a tread part connecting the sidewall parts, and a belt layer is disposed in the tread part. Further, in the tire, a reinforcing rubber having hardness higher than that of the tread part and the sidewall part is arranged so as to protrude toward a sidewall part side from an end part of the belt layer. According to the tire according to Patent Literature 1, the rim slip-off resistance can be improved.

### CITATION LIST

### Patent Literature

Patent Literature 1: JP 2007-083946 A

### SUMMARY OF INVENTION

### Technical Problem

In the conventional art, as the tire described above, the technique to improve the rim slip-off resistance is proposed, however further improvement is desired.

An object of the present invention is, in consideration of the problem described above, to provide a tire capable of improving rim slip-off resistance.

### Solution to Problem

In order to solve the problem described above, the present inventors conducted a study regarding a bead unseating in detail. As a result, it is found that, in the pneumatic tire, a buckling phenomenon (described in detail below) is occurred on a bead part in a process to the bead unseating.

A tire (pneumatic tire 1) according to a first aspect of the present invention includes a bead part (bead part 29 having a bead core (bead core 10), and carcass layer (carcass layer 3) folded around the bead core in the bead part. The bead part includes a bead inner-face part (bead inner-face part 21) defined as a region at an inner side of the carcass layer in a tire width direction and at an outer side of a bead toe (bead toe 2a) in a tire radial direction, a bead base part (bead base part 22) defined as a region at an inner side of the carcass layer in the tire radial direction and at an outer side of the bead toe in the tire width direction, and a high-hardness rubber layer (high-hardness rubber layer 100) having hardness higher than hardness of the bead base part and provided in at least a part of the bead inner-face part.

A thickness of the high-hardness rubber layer in the tire according to the first aspect of the present invention may be set in a range of 5% to 25% of a width of the bead part at a center position of the bead core in the tire width direction.

The high-hardness rubber layer in the tire according to the first aspect of the present invention may be formed of a rubber member having the durometer A hardness in a range of 75° to 100°.

A projection (projection 200) projected toward an inner side in the tire width direction may be formed on the high-hardness rubber layer at an inner side in the tire width direction in the bead inner-face part in the tire according to the first aspect of the present invention.

A reinforcing cord layer (reinforcing cord layer 300) may be provided inside the bead inner-face part in the tire according to the first aspect of the present invention.

The reinforcing cord layer in the tire according to the first aspect of the present invention may include a cord extended in a direction inclined against a tire circumferential direction.

A high-friction part (high-friction part 400) having friction coefficient against a predetermined target surface larger than friction coefficient of the bead base part against the predetermined target surface may be provided on a surface of the bead inner-face part in the tire according to the first aspect of the present invention.

The tire according to the first aspect of the present invention may be a tire with a designated mounting direction with respect to a vehicle, and the bead part may be provided only at an outer side in the mounting direction with respect to the vehicle.

### Advantageous Effects of Invention

The present invention provides a tire capable of improving rim slip-off resistance.

### BRIEF DESCRIPTION OF DRAWINGS

FIG. 1 illustrates a partial cross-sectional view of a pneumatic tire along a tire width direction and a tire radial direction according to a first embodiment.

FIG. 2 illustrates an enlarged cross-sectional view of a bead part of the pneumatic tire according to the first embodiment.

FIG. 3A illustrates a cross-sectional view describing a process of a bead-unseating test in a pneumatic tire according to a conventional art.

FIG. 3B illustrates a cross-sectional view describing the process of the bead-unseating test in the pneumatic tire according to the conventional art.

FIG. 4 illustrates a cross-sectional view describing a function and an effect of the pneumatic tire according to the first embodiment.

FIG. 5A illustrates an enlarged cross-sectional view of a configuration of a pneumatic tire according to a variation of the first embodiment.

FIG. 5B illustrates an enlarged cross-sectional view of a configuration of a pneumatic tire according to a variation of the first embodiment.

FIG. 5C illustrates an enlarged cross-sectional view of a configuration of a pneumatic tire according to a variation of the first embodiment.

### DESCRIPTION OF EMBODIMENTS

### First Embodiment

Next, a tire according to a first embodiment of the present invention is described with reference to drawings. Further, in the description of the drawings, the same or a similar numeral reference is assigned to the same or a similar part. Further, the drawings are schematically shown, and therefore the proportion in dimensions of each component shown in the drawings may be different from that of the actual component. Accordingly, specific proportion in dimensions of the component should be determined in view of the following description. Further, the proportion or the relationship in dimensions of the components may be different between the drawings.

### (1) A Whole Configuration of a Pneumatic Tire

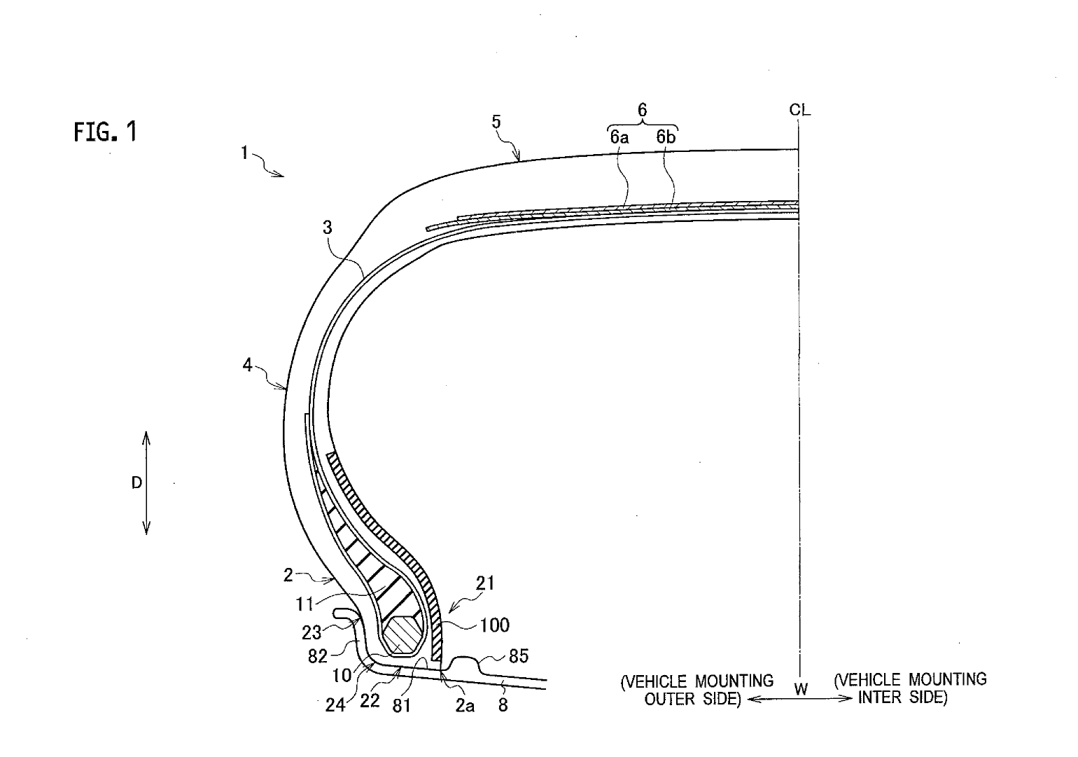

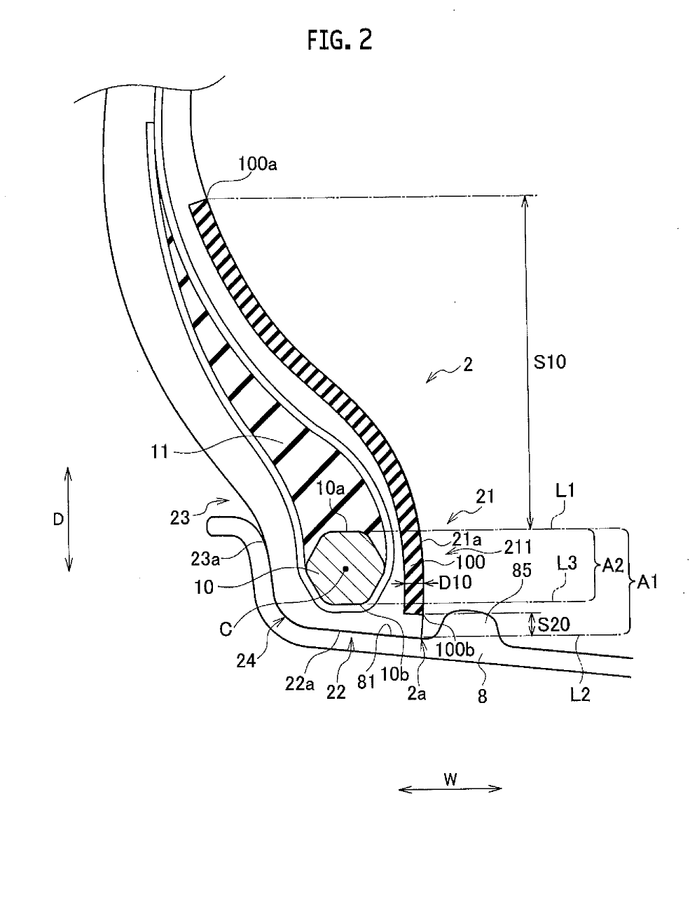

FIG. 1 illustrates a partial cross-sectional view of a pneumatic tire 1 along a tire width direction W and a tire radial direction D according to the first embodiment. FIG. 2 illustrates an enlarged cross-sectional view of a bead part of the pneumatic tire 1 according to the first embodiment.

The pneumatic tire 1 has a pair of bead parts 2, a carcass layer 3, a sidewall part 4, and a tread part 5. Here, in an example shown in FIG. 1, one of the bead parts 2 among the pair of the bead parts is illustrated, and another bead part is omitted.

Further, a rim wheel 8 is mounted to the pneumatic tire 1. The rim wheel 8 has a hump part 85 formed on a surface at a side where the tire is contacted. When the pneumatic tire 1 is assembled to the rim wheel 8, a seal part 81 and a flange part 82 of the rim wheel 8 are contacted with the bead part 2 of the pneumatic tire 1. Here, the rim wheel 8 is a normal rim.

The “normal rim” corresponds to a standard rim in applied size defined in Year Book 2008 of JATMA (Japan Automobile Tyre Manufacturers Association). In countries other than Japan, the “normal rim” corresponds to a standard rim in applied size defined in a standard described below. Specifically, the standard is defined in accordance with an industrial standard effective in a region where the tire is manufactured or used. For example, the standard is defined in “Year Book of The Tire and Rim Association (TRA) Inc.” in the U.S., and “Standards Manual of The European Tyre and Rim Technical Organization (ETRTO)” in the Europe.

The bead part 2 has a bead core 10 and a bead filler 11. The bead part 2 is formed to contact with the rim 8 at an inner side in the tire radial direction D.

The carcass layer 3 is extended toroidally between the pair of the bead cores 10. The carcass layer 3 is folded at the bead part 2 around the bead core 10.

Further, the bead part 2 has a bead inner-face part 21 arranged at an inner side of the carcass layer 3 in the tire width direction W, a bead base part 22 arranged at an inner side of the carcass layer 3 in the tire radial direction D, and a bead outer-face part 23 arranged at an outer side of the carcass layer 3 in the tire width direction W. Further, a bead heel part 24 which connects the bead base part 22 and the bead outer-face part 23 is arranged between the bead base part 22 and the bead outer-face part 23.

The bead inner-face part 21 is a region at the inner side of the carcass layer 3 in the tire width direction W and an outer side of a bead toe 2a in the tire radial direction D. Further, in the present embodiment, in a section in the tire width direction W, the bead inner-face part 21 is defined as a region A1 between, an upper virtual line L1 passing an end part 10a of the bead core 10 at an outer side in the tire radial direction D and extending along the tire width direction W, and a lower virtual line L2 passing the bead toe 2a and extending along the tire width direction W.

A bead inner surface 21a extended outwardly from the bead toe 2a in the tire radial direction D is arranged on the bead inner-face part 21. When the pneumatic tire 1 is assembled to the rim wheel 8, the bead inner surface 21a of the bead inner-face part 21 is arranged so as to be separated from the hump part 85 of the rim wheel 8. In other words, when the pneumatic tire 1 is assembled to the rim wheel 8, the bead toe 2a is arranged so as to be separated from the hump part 85 of the rim wheel 8.

The bead base part 22 is a region at the inner side of the carcass layer 3 in the tire radial direction and an outer side of the bead toe 2a in the tire width direction W. A bead base surface 22a extended outwardly from the bead toe 2a in the tire width direction W is arranged on the bead base part 22. The bead base surface 22a is extended from the bead toe 2a to the bead heel part 24. When the pneumatic tire 1 is assembled to the rim wheel 8, the bead base surface 22a is contacted with the seal part 81 of the rim wheel 8. Further, the bead base part 22 is preferably formed of a rubber member having durometer A hardness in a range of 55° to 65° in view of securing rim assembling performance of the pneumatic tire 1 against the rim wheel 8.

Further, the bead base part 22 is formed in a linear shape in a section in the tire width direction W. Further, the bead heel part 24 is formed in an arc shape in the section in the tire width direction W. A boundary between the bead base part 22 and the bead heel part 24 may be formed by a part where the shape of the section in the tire width direction W is changed from the linear shape to the arc shape.

The bead outer-face part 23 has a bead outer surface 23a extended outwardly from the bead heel part 24 in the tire radial direction D. When the pneumatic tire 1 is assembled to the rim wheel 8, the bead outer surface 23a is contacted with the flange part 82 of the rim wheel 8.

The tread part 5 has a ground contact surface which contacts with the ground. A belt layer 6 which reinforces the tread part 5 is formed at an inside of the tread part 5 in the tire radial direction D. The belt layer 6 has a plurality of belt layers 6a, 6b formed of high strength organic fiber cord or steel cord.

The sidewall part 4 is connected to an outer side of the bead part 2 in the tire radial direction D. The sidewall part 4 is extended between the bead part 2 and the tread part 5.

### (2) A Configuration of the Bead Part

Next, a configuration of the bead part is described in detail. As shown in FIG. 2, a high-hardness rubber layer 100 is formed in the bead part 2 according to the present embodiment. Specifically, the bead part 2 has the high-hardness rubber layer 100, which has hardness higher than that of the bead base part 22, in at least a part of the bead inner-face part 21 of the bead part 2.

The high-hardness rubber layer 100 is formed in at least the part of the bead inner-face part 21. Further, it may be also described that at least a part of the high-hardness rubber layer 100 is formed in the bead inner-face part 21. Further, the high-hardness rubber layer 100 may be formed in the whole range of the bead inner-face part 21.

Here, in the present embodiment, the high-hardness rubber layer 100 is arranged so as to be formed firmly at the outer side of the bead core 10 in the tire width direction W. Specifically, in the present embodiment, the bead inner-face part 21 has a bead core inner part 211, and the high-hardness rubber layer 100 is formed so as to include the whole part of the bead core inner part 211. Here, the bead core inner part 211 is a region A2 between, the upper virtual line L1 passing the end part 10a of the bead core 10 at the outer side in the tire radial direction D and extending along the tire width direction W, and an intermediate virtual line L3 passing an end part 10b of the bead core 10 at an inner side in the tire radial direction D and extending along the tire width direction W.

The high-hardness rubber layer 100 is preferably formed continuously in a tire circumferential direction (namely, a direction orthogonal to the tire width direction W and the tire radial direction D).

Further, the high-hardness rubber layer 100 may be formed of a rubber member having the durometer A hardness in a range of 75° to 100°. Further, the high-hardness rubber layer 100 is further preferably formed of a rubber member having the durometer A hardness in a range of 90° to 100°.

A thickness D10 of the high-hardness rubber layer 100 is preferably in a range of 5% to 25% of a width of the bead part 2 at a center position C of the bead core 10 in the tire width direction W. Specifically, the width of the bead part 2 is defined by a width between the bead inner surface 21a and the bead outer surface 23a in the tire width direction W, and the thickness D10 of the high-hardness rubber layer 100 is preferably set in a range of 5% and 20% of the width of the bead part 2. Further, the thickness D10 of the high-hardness rubber layer 100 is further preferable to be more than 10%.

Further, the high-hardness rubber layer 100 is preferably arranged at a side of the bead inner surface 21a of the bead inner-face part 21. For example, the high-hardness rubber layer 100 is preferably arranged so as to be exposed to the bead inner surface 21a.

An end part 100a of the high-hardness rubber layer 100 at the outer side in the tire radial direction D may be arranged at the inner side in the tire radial direction D than the upper virtual line L1. Further, the end part 100a of the high-hardness rubber layer 100 may be arranged at the outer side in the tire radial direction D than the upper virtual line L1 in view of arranging the high-hardness rubber layer 100 on the upper virtual line L1. Further, in a case in which the end part 100a of the high-hardness rubber layer 100 is arranged at the outer side in the tire radial direction D than the upper virtual line L1, a distance S10 between the end part 100a of the high-hardness rubber layer 100 and the upper virtual line L1 in the tire radial direction D is irrelevant to bead-unseating performance. Thus, the distance S10 may be changed in accordance with the thickness D10 of the high-hardness rubber layer 100. With such a change, in an extrusion process which forms the high-hardness rubber layer 100, productivity including formability of the high-hardness rubber layer 100 (easiness in manufacturing of hard rubber in the extrusion process) can be improved.

The end part 100b of the high-hardness rubber layer 100 at the inner side in the tire radial direction D may be arranged at an outer side in the tire radial direction D than the intermediate virtual line L3. The end part 100b of the high-hardness rubber layer 100 at the inner side in the tire radial direction D may be arranged so as to be separated from the bead toe 2a toward the outer side in the tire radial direction D at a predetermined distance S20. The predetermined distance S20 may be less than ⅓ of the thickness (maximum thickness) in the tire radial direction D, which is a distance between the end part 10b of the bead core 10 at the inner side in the tire radial direction D and a bead base surface 22a of the bead base part 22. In this case, when the pneumatic tire 1 is assembled to the rim wheel 8, since break of a tip of the bead toe 2a can be prevented, the rim assembling performance can be improved.

### (3) Functions and Effects

Functions and effects of the present embodiment are described. Here, at first, a study conducted by the present inventors is described.

The present inventors conducted the study in detail regarding the bead unseating in order to improve durability performance against the bead unseating (rim slip-off resistance). As a result, it is found that, in the pneumatic tire, a buckling phenomenon (described in detail below) is occurred on the bead part in the process to the bead unseating.

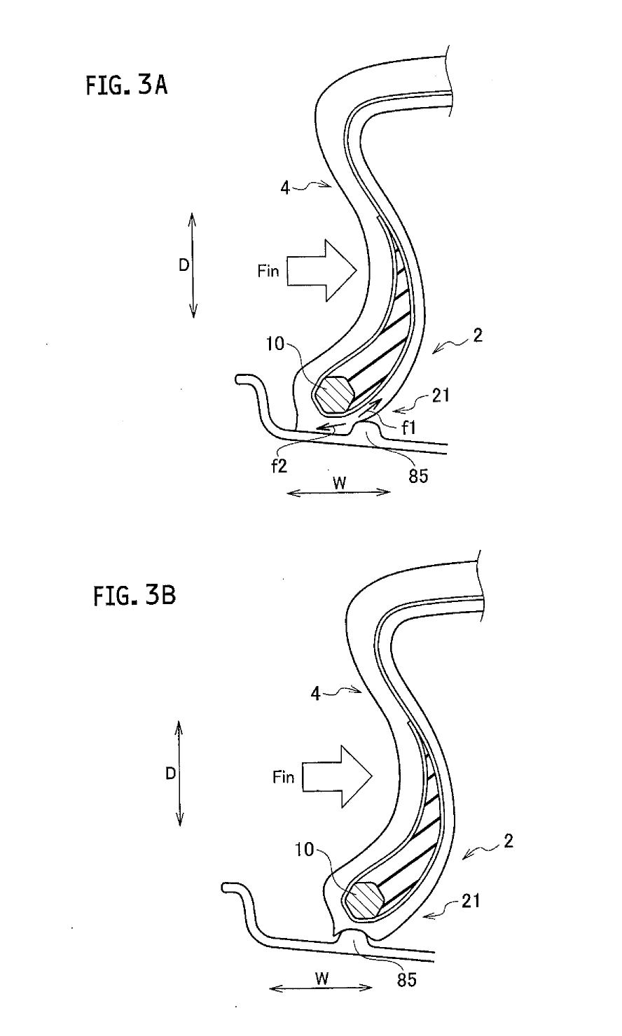

FIG. 3A and FIG. 3B illustrate cross-sectional views that describe process of a bead-unseating test in a tire according to a conventional art. As shown in FIG. 3A, when lateral force Fᵢₙ toward the inner side in the tire width direction W is applied to the pneumatic tire, a phenomenon (hereinafter, referred to as a buckling phenomenon) in which the sidewall part 4 is bent and the bead inner-face part 21 of the bead part 2 is inclined is occurred. When the budding phenomenon is occurred, the bead inner-face part 21 of the bead part 2 is contacted with the hump part 85 of the rim wheel 8. At this time, a rubber member of the bead inner-face part 21 of the bead part 2 is deformed toward the tire radial direction D. Specifically, the rubber member for the bead inner-face part 21 is deformed based on flow of f1, f2 shown in FIG. 3A. As a result, a gap between, the bead core 10 and the carcass layer 3, and the hump part 85 becomes narrower. Then, as shown in FIG. 3B, when the bead core 10 and the carcass layer 3 are moved beyond the hump part 85 while the bead inner surface 21a of the bead inner-face part 21 of the bead part 2 is sliding on a surface of the hump part 85, the bead unseating (rim slip-off) is occurred.

Further, the present inventor found that even if the buckling phenomenon is occurred, unless the bead core 10 and the carcass layer 3 are moved beyond the hump part 85, the bead core 10 and the carcass layer 3 are returned to their original positions after the lateral force Fᵢₙ disappears.

In this way, the present inventor found the knowledge that the rim slip-off resistance can be improved by generating resistance force Fₒᵤₜ toward the outer side in the tire width direction W in order not to move the bead core 10 and the carcass layer 3 beyond the hump part 85 when the buckling phenomenon is occurred, and then the present inventor completed the present invention.

The pneumatic tire 1 according to the first embodiment of the present invention has the bead part 2. The bead part 2 has the bead inner-face part 21. The high-hardness rubber layer 100 having rubber hardness higher than that of the bead base part 22 is arranged in at least a part of the bead inner-face part 21.

According to such a configuration, since the high-hardness rubber layer 100 is arranged in the bead inner-face part 21, even if the buckling phenomenon is occurred, the resistance force Fₒᵤₜ toward the outer side in the tire width direction W can be generated by contacting the high-hardness rubber layer 100 with the hump part 85 of the rim wheel 8.

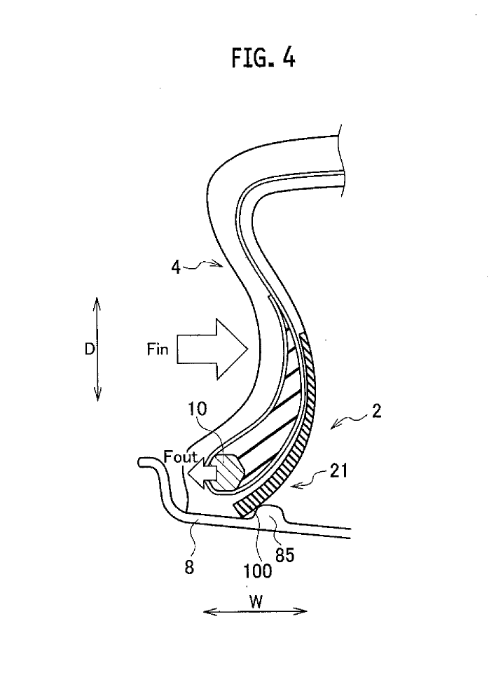

Here, FIG. 4 illustrates a cross-sectional view that describes a state in which the buckling phenomenon is occurred when the lateral force Fᵢₙ is applied to the pneumatic tire 1 according to the present embodiment. As shown in FIG. 4, when the buckling phenomenon is occurred on the pneumatic tire 1, the bead inner-face part 21 of the bead part 2 is contacted with the hump part 85. At this time, since the high-hardness rubber layer 100 in the bead inner-face part 21 suppresses to deform toward the tire radial direction D, the gap between, the bead core 10 and the carcass layer 3, and the hump part 85 can be secured by the high hardness rubber layer 100. Further, rigidity of a part between a part of the bead inner-face part 21 contacting with the hump part 85 and the bead core 10 can be enhanced compared to a configuration without the high-hardness rubber layer 100. Since the resistance force Fₒᵤₜ against the lateral force Fᵢₙ is generated, the rim slip-off resistance can be improved.

In this way, according to the pneumatic tire 1 according to the present embodiment, the rim slip-off resistance can be improved.

Further, as a simple method to arrange the high-hardness rubber layer in the bead inner-face part 21, a method to replace rubber for chafer arranged in a region from the bead inner-face part 21 to the bead base part 22 in the conventional tire with rubber for the high-hardness rubber layer is considered. However, when the whole part of the rubber for the chafer is replaced with the rubber for the high-hardness rubber layer, the high-hardness rubber layer is also arranged in the bead base part 22, and therefore deterioration of the rim assembling performance and deterioration of the durability performance such as generation of crack or the like may be concerned. On the other hand, in the pneumatic tire 1 according to the present embodiment, since the high-hardness rubber layer is arranged only in the bead inner-face part 21, the deterioration of the rim assembling performance and the deterioration of the durability performance can be prevented.

Further, in the present embodiment, the high-hardness rubber layer 100 is arranged in at least the part of the bead inner-face part 21. Here, the bead inner-face part 21 is contacted with the hump part 85 when the buckling phenomenon is occurred. Namely, according to such a configuration, since the high-hardness rubber layer 100 is arranged in the part of the bead inner-face part 21, the resistance force Fₒᵤₜ can be firmly generated.

Further, the high-hardness rubber layer 100 may be arranged only in the bead core inner part 211. In this case, the end part 100a of the high-hardness rubber layer 100 at the outer side in the tire radial direction D is located on the upper virtual line L1, and the end part 100b of the high-hardness rubber layer 100 at the inner side in the tire radial direction D is located on the intermediate virtual line L3. According to such a configuration, the resistance force Fₒᵤₜ can be generated while suppressing an amount of the high-hardness rubber layer 100.

Further, the high-hardness rubber layer 100 is preferably formed of a rubber member having the durometer A hardness in a range of 75° to 100°. According to such a configuration, since the high-hardness rubber layer 100 is formed of the rubber member having higher hardness, the high-hardness rubber layer 100 is hardly pressed and crushed when the buckling phenomenon is occurred. That is, the gap between, the bead core 10 and the carcass layer 3, and the hump part 85 can be firmly secured by the rubber member forming the high-hardness rubber layer 100. With this, the resistance force Fₒᵤₜ against the lateral force Fᵢₙ is generated, and therefore the rim slip-off resistance can be improved.

Further, in a case in which the rubber member has the durometer A hardness of more than 75°, since the rim slip-off resistance can be firmly improved, it is preferable that the durometer A hardness is more than 75° in view of firmly improving the rim slip-off resistance. On the other hand, in a case in which the rubber member has the durometer A hardness of more than 100°, further improvement of the rim slip-off resistance is not obtained, and crack might be generated easily. Further, it is further preferable that the high-hardness rubber layer 100 is formed of the rubber member having the durometer A hardness in a range of 90° to 100°.

Further, the thickness D10 of the high-hardness rubber layer 100 is preferably in a range of 5% to 25% of the width of the bead part at the center position C of the bead core 10 in the tire width direction W. Specifically, the width of the bead part 2 is defined by a width between the bead inner surface 21a and the bead outer surface 23a, and the thickness D10 of the high-hardness rubber layer 100 is preferably set in a range of a ratio between 3% and 15% of the width of the bead part 2.

In a case in which the thickness D10 of the high-hardness rubber layer 100 is more than 5% of the width of the bead part 2, the rim slip-off resistance can be firmly improved. Further, it is preferable that the thickness D10 of the high-hardness rubber layer 100 is more than 10% of the width of the bead part 2 in view of further improving the rim slip-off resistance. Further, in a case in which the thickness D10 of the high-hardness rubber layer 100 is more than 25% of width of the whole bead part 2, the assembling performance (namely, the rim assembling performance) between the pneumatic tire 1 and the rim wheel 8 might be deteriorated.

The end part 100b of the high-hardness rubber layer 100 at the inner side in the tire radial direction D may be arranged so as to be separated from the bead toe 2a toward the outer side in the radial direction D at the predetermined distance S20. According to such a configuration, workability in assembling the pneumatic tire 1 to the rim wheel 8 is enhanced. Further, since the bead part 2 is easily adhered to the seal part 81 of the rim wheel 8, the deterioration of the rim assembling performance can be also prevented.

Further, the pneumatic tire 1 may be formed as a tire in which a mounting direction to the vehicle is designated. Specifically, the pneumatic tire 1 may have a vehicle mounting outer side located at an outer side in a width direction of the vehicle when the tire is mounted to the vehicle, and a vehicle mounting inner side located at an inner side in the width direction of the vehicle when the tire is mounted to the vehicle. In this case, the bead part 2 having the high-hardness rubber layer 100 may be arranged only at an outer side in the mounting direction to the vehicle. In other words, the high-hardness rubber layer 100 may be arranged only in the bead part 2 located at the outer side in the vehicle mounting direction than a tire equatorial plane CL. With such a configuration, the rim slip-off resistance relating to the bead unseating can be also improved. Further, according to such a configuration, an amount of the high-hardness rubber layer 100 can be suppressed compared to a configuration in which the high-hardness rubber layer 100 is formed in both of the bead parts 2 located in the vehicle mounting inner side and the vehicle mounting outer side. With this, a cost in manufacturing can be suppressed, and efficiency in manufacturing can be enhanced.

Further, the pneumatic tire 1 according to the embodiment of the present invention is preferably used for a tire defined as a vehicle tire in the standard. Here, examples of the standard include Year Book of JATMA, Year Book of TRA, Standards Manual of ETRTO and the like.

Further, the reason that the pneumatic tire 1 according to the embodiment of the present invention is suitable for the vehicle tire is as described below. Specifically, in a track or bus tire or a heavy load tire other than the vehicle tire, since inner pressure is high and contact pressure between the rim and the tire is high, the durability performance against the bead unseating (rim slip-off resistance) hardly becomes a problem. Further, the pneumatic tire 1 may be formed as a tire applicable to the bead-unseating test corresponding to the standards such as Japanese Industrial Standards (Standard No. JIS D4230) or Chinese National Standards (Standard Number: total T trial 182).

Further, the high-hardness rubber layer 100 is preferably arranged continuously in the tire circumferential direction. According to such a configuration, since the resistance force Fₒᵤₜ against the lateral force Fᵢₙ is generated when the lateral force Fᵢₙ is applied to an arbitrary part in the tire circumferential direction, the rim slip-off resistance can be firmly obtained.

### Variations

Next, variations of the aforementioned first embodiment are described by focusing on the differences against the configuration of the first embodiment. Further, each of the variations can be combined with other variation.

### Variation 1

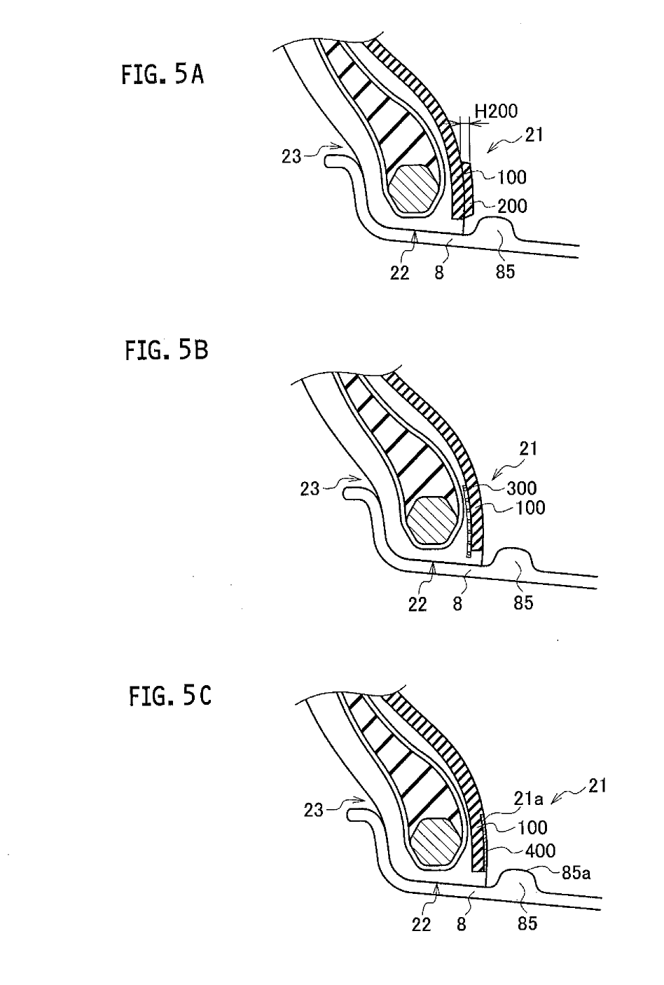

A variation 1 of the aforementioned first embodiment is described. FIG. 5A illustrates an enlarged cross-sectional view of a pneumatic tire according to the variation 1. In the bead inner-face part 21 according to the present embodiment, a projection part 200 projected toward the inner side in the tire width direction W is arranged on the high-hardness rubber layer 100 at the inner side in the tire width direction W. Here, the projection part 200 may be arranged only in the bead core inner part 211.

Further, in the present embodiment, the high-hardness rubber layer 100 and the projection part 200 are formed of the rubber member having the durometer A hardness in a range of 75° to 100°. Further, the high-hardness rubber layer 100 and the projection part 200 may be formed of the rubber member having the durometer A hardness in a range of 90° to 100°.

According to such a configuration, even if the buckling phenomenon is occurred in the pneumatic tire 1, a gap between, the bead core 10 and the carcass layer 3, and the hump part 85 can be firmly secured by the rubber member forming the projection part 200. With this, the resistance force Fₒᵤₜ against the lateral force Fᵢₙ is generated, and therefore the rim slip-off resistance can be further improved.

Further, a height (thickness) H200 of the projection part 200 in the tire width direction W is preferably in a range of 3% to 15% of the width of the bead part 2 at the center position C of the bead core 10 in the tire width direction W. Specifically, the width of the bead part 2 is defined by a width between the bead inner surface 21a and the bead outer surface 23a in the tire width direction W, and the height H200 of the projection part 200 is preferably set in a range of a ratio between 3% and 15% of the width of the bead part 2. The height H200 of the projection part 200 is further preferably set in a range of 5% to 10% of the width of the bead part 2 at the center position C of the bead core 10 in the tire width direction W. Further, the height H200 of the projection part 200 may be less than 1 mm.

Further, the projection part 200 may be formed as another member than the high-hardness rubber layer 100 and the projection part 200 may be adhered to the high-hardness rubber layer 100. Specifically, the projection part 200 may be adhered to the high-hardness rubber layer 100 by an adhesive.

Further, in this case, the pneumatic tire 1 is manufactured through a process to adhere the projection part 200 after a process to form the pneumatic tire by means of vulcanizing and molding. According to such a configuration, since the projection part 200 is formed as another member than the high-hardness rubber layer 100, a processing cost to form a part for forming the projection part 200 in a vulcanizing forming mold is unnecessary. Further, since the projection part 200 can be arranged at a desired position in a stable state after the vulcanizing and molding, unnecessary rubber (margin) can be reduced. Quality (manufacturing) of the tire can be stable by suppressing a cost in manufacturing of the pneumatic tire.

### Variation 2

A variation 2 of the aforementioned first embodiment is described. FIG. 5B illustrates an enlarged cross-sectional view of a pneumatic tire according to the variation 2. In the bead inner-face part 21 according to the present embodiment, a reinforcing cord layer 300 is arranged. Further, the reinforcing cord layer 300 preferably has a cord extended in a direction inclined against the tire circumferential direction. Specifically, the reinforcing cord layer 300 is arranged in the bead inner-face part 21 at the outer side of the high-hardness rubber layer 100 in the tire width direction W. Further, the reinforcing cord layer 300 may be arranged only in the bead core inner part 211.

According to such a configuration, since the reinforcing cord layer 300 is arranged, even if the bead inner-face part 21 of the bead part 2 is contacted with the hump part 85 when the buckling phenomenon is occurred, the rubber member for the bead inner-face part 21 is further suppressed to deform toward the tire radial direction D. Especially, since the reinforcing cord layer 300 has the cord extended in the direction inclined against the tire circumferential direction, the deformation of the rubber member toward the tire radial direction D can be firmly suppressed.

According to such a configuration, when the buckling phenomenon is occurred, the bead inner-face part 21 can be firmly prevented to be pressed and crashed. With this, the gap between, the bead core 10 and the carcass layer 3, and the hump part 85 can be secured. Further, since rubber has incompressibility, the rigidity of the bead inner-face part 21 can be substantially higher by suppressing the flow f1, f2 of the rubber compared to a configuration without the reinforcing cord layer 300. With those, the resistance force Fₒᵤₜ against the lateral force Fᵢₙ is increased. Thus, the rim slip-off resistance can be further improved.

Further, in the present embodiment, the reinforcing cord layer 300 is formed of a single cord layer (single layer) as an example, however the reinforcing cord layer 300 may have a plurality of cord layers. Specifically, the reinforcing cord layer 300 may be formed by laminating a first cord layer having a first cord and a second cord layer having a second cord. In this case, each of an extending direction of the first cord and an extending direction of the second cord is preferably extended in a direction inclined against the tire circumferential direction. Further, the extending direction of the first cord may be different from the extending direction of the second cord.

According to such a configuration, since the extending direction of the first cord and the extending direction of the second cord are different from each other in the reinforcing cord layer 300, tension force of the cord can be generated in a plurality of directions. Thus, when the buckling phenomenon is occurred, the deformation of the rubber member is further suppressed, and the bead inner-face part 21 is hardly pressed and crashed. That is, the gap between, the bead core 10 and the carcass layer 3, and the hump part 85 can be firmly secured by the reinforcing cord layer 300. Further, since rubber has incompressibility, the rigidity of the bead inner-face part 21 can be substantially higher by suppressing the flow f1, f2 of the rubber compared to a configuration without the reinforcing cord layer 300. With those, since the resistance force Fₒᵤₜ against the lateral force Fᵢₙ is generated, the rim slip-off resistance can be improved.

Further, in the reinforcing cord layer 300, the cord may be extended in a direction orthogonal to the tire circumferential direction, or a direction inclined against the tire circumferential direction at 90 degrees. In other words, the cord may be formed so as to extend in the tire radial direction D. Here, it is considered that a deformation amount of the rubber member for the bead inner-face part 21 toward the tire radial direction D becomes the maximum when the buckling phenomenon is occurred. Thus, according to such a configuration, the deformation of the rubber member toward the tire radial direction D can be firmly suppressed. Such a configuration is especially effective in a configuration in which the reinforcing cord layer 300 is formed of a single layer.

Further, in a case in which the reinforcing cord layer 300 has a plurality of cord layers, at least one cord layer included in the plurality of the cord layers may have a cord extended in the direction orthogonal to the tire circumferential direction, or the tire radial direction D.

### Variation 3

A variation 3 of the aforementioned first embodiment is described. FIG. 5C illustrates an enlarged cross-sectional view of a pneumatic tire according to the variation 3. In the bead inner surface 21a (surface) of the bead inner-face part 21 according to the present embodiment, a high-friction part 400 having friction coefficient larger than friction coefficient of the bead base part 22 against a predetermined target surface. Specifically, the friction coefficient of the high friction part 400 is larger than the friction coefficient of the bead base surface 22a of the bead base part 22. Further, the high-friction part 400 is arranged on a surface of the high-hardness rubber layer 100 at the inner side in the tire width direction W.

Further, in the present embodiment, the predetermined target surface corresponds to a surface of the rim wheel 8 at the outer side in the tire radial direction D. Specifically, the predetermined target surface corresponds to a surface 85a of the hump part 85 at the outer side in the tire radial direction D.

That is, the friction coefficient of the high-friction part 400 against the surface 85a of the hump part 85 is larger than the friction coefficient of the bead base surface 22a against the surface 85a of the hump part 85. In other words, friction force on the high-friction part 400 against the surface 85a of the hump part 85 is larger than friction force on the bead base surface 22a against the surface 85a of the hump part 85.

Further, for example, as a method for providing the friction coefficient of the high-friction part 400, a method to incorporate an additive such as silica into the rubber member for the high-friction part 400 may be adopted. As other example of the method, a method to use rubber having the high loss tangent tan δ, a method to increase a surface area by forming projections and recesses, or a method to adhere a high friction coefficient member such as safety fork on a surface may be adopted.

According to such a configuration, since the high-friction part 400 is arranged in the bead inner surface 21a, when the buckling phenomenon is occurred and the high-friction part 400 is contacted with the hump part 85, the bead inner-face part 21 is hardly moved toward the inner side in the tire width direction W. That is, since the resistance force against the lateral force Fᵢₙ is increased, the rim slip-off resistance can be further improved.

Further, the friction coefficient of the high-friction part 400 and the friction coefficient of the bead base surface 22a can be acquired by the following measuring method. Specifically, a rubber piece of the high-friction part 400 and a rubber piece of the bead base part 22 are formed. Then, the friction coefficient is measured by contacting each rubber piece on a surface (the predetermined target surface) of a member similar to the surface 85a of the hump part 85. Each maximum friction coefficient value (μ) acquired at this time corresponds to each of the friction coefficient of the high-friction part 400 and the friction coefficient of the bead base surface 22a.

Further, well-known various methods may be adopted in the method for measuring the friction coefficient of the rubber piece. For example, the friction coefficient of the rubber piece may be measured by a method corresponding to Standard No. JIS K7125 by using a friction coefficient measuring device (a slip tester made by YASUDA SEIKI SEISAKUSHO, LTD. or the like). Other than this, the friction coefficient of the rubber piece may be measured by using the ball (pin)-on-disk rotating method (for example, Standard No. JISR 1613-1993), the ball (pin)-on-disk reciprocating method (for example, Standard No. JISR 1613-1993), the thrust cylinder method (for example, Standard No. JISK7218), the block-on-ring method (for example, Standard No, ASTM G77-05), the four-ball method (for example, Standard No. JIS K2519), the pin-block method (for example, Standard No. ASTM D2625-94(2003)) or the like.

Further, the friction coefficient of the high-friction part 400 is preferably more than 1.5 times, more preferably more than 2 times as the friction coefficient of the bead base surface 22a.

### Comparative Evaluation

Next, in order to clarify the effects of the present invention, a comparative evaluation carried out by using the pneumatic tires according to comparative examples and examples is described below. Further, the present invention is not limited to these examples.

### (1) Evaluation Method

The bead-unseating test is carried out by using a plurality of kinds of tires, and then the rim slip-off resistance is evaluated. Further, the bead-unseating test is carried out by a numerical analysis test by means of the finite element method (FEM), and by an experiment using an actual tire.

At first, tires according to the comparative examples and tires according to the examples are prepared. Specifically, in order to conduct the numerical analysis test by means of the finite element method (FEM), a tire (tire model) according to the comparative example and tires (tire models) according to the examples 1 to 7 are formed. A method to form the tire modes for the finite element method (FEM) is used a well-known method, and therefore its description in detail is omitted. Further, in order to perform experiment with the actual tire, a tire (actual tire) according to the comparative example A and tires (actual tires) according to the examples A1 to A3 are prepared. Further, a tire size of the tire (tire model) according to the comparative examples and the examples 1 to 7 is 275/30ZR20, and a tire size of the tire (actual tire) according to the comparative example A and the examples A1 to A3 is 265/35ZR20. Here, the rim slip-off resistance is not affected by the difference between the tire sizes of the tires.

As the tire according to each of the comparative example and the comparative examples A, a tire without the high-hardness rubber layer in the bead inner-face part 21 is used. As the tire according to each of the examples 1 to 7 and the examples A1 to A3, a tire having the high-hardness rubber layer in the bead inner-face part 21 is used.

Further, in the tires according to the examples 1 to 7 and the examples A1 to A3, the end part of the high-hardness rubber layer at the outer side in the tire radial direction D is located at the outer side in the tire radial direction D than the bead core inner part 211, and the end part of the high-hardness rubber layer at the inner side in the tire radial direction D is located at the inner side in the tire radial direction D than the bead core inner part 211. Further, in the tires according to the examples 1 to 5, the length of the high-hardness rubber layer in the tire radial direction D is 15 mm, and it is longer than the length of the bead core inner part 211 in the tire radial direction D. Further, in the tire according to the example 5, a projection part is formed on the high-hardness rubber layer at the inner side in the tire width direction W. In the tire according to the example 6, the high-hardness rubber layer is located only in the bead core inner part 211, and the length of the high-hardness rubber layer in the tire radial direction D is shorter than the length of the bead core inner part 211 in the tire radial direction D. Each of the configurations of the tires is shown in Tables 1 and 2.

As the bead unseating test, a test method corresponding to the Chinese GB Standard (Standard Number: total T trial 182) is adopted. Further, in the test, the maximum valve of the resistance force applied in the tire width direction until the bead part is slipped off from the rim is acquired in each of the numerical analysis test by means of the finite element method (FEM) and the experiment using the actual tire. Then, the maximum values of the acquired resistance force are compared.

### (2) Evaluation Result

Table 1 shows the result of the numerical analysis test by means of the finite element method (FEM), and Table 2 shows the result of the experiment. Further, each of the durometer A hardness in Tables 1, 2 is acquired by the method corresponding to DISK 6253.

TABLE 1

| | Comparative | Example | Example | Example | Example | Example | Example | Example |
|---|---|---|---|---|---|---|---|---|
| | Example | 1 | 2 | 3 | 4 | 5 | 6 | 7 |
| Thickness of High-Hardness Rubber Layer | — | 13 | 13 | 13 | 5 | 13 | 13 | 11 |
| D10 with respect to Bead Part 2 (%) | | | | | | | | |
| Thickness of High-Hardness Rubber Layer | — | 1.63 | 1.63 | 1.63 | 0.59 | 1.63 | 1.63 | 1.41 |
| D10 (Maximum Value) (mm) | | | | | | | | |
| Length of High-Hardness Rubber Layer in | — | 15 | 15 | 15 | 15 | 15 | 4.5 | 45 |
| Tire Radial Direction (mm) | | | | | | | | |
| Durometer A Hardness of Rubber Member | — | 75 | 80 | 95 | 95 | 95 | 95 | 95 |
| for High-Hardness Rubber Layer (°) | | | | | | | | |
| Durometer A Hardness of Rubber Member | 60 | 60 | 60 | 60 | 60 | 60 | 60 | 60 |
| for Bead Base Part (°) | | | | | | | | |
| Durometer A Hardness of Rubber Material | — | — | — | — | — | 95 | — | — |
| for Projection Part (°) | | | | | | | | |
| Height of Projection Part (mm) | — | — | — | — | — | 1 | — | — |
| Length of Projection Part in Tire Radial | — | — | — | — | — | 15 | — | — |
| Direction (mm) | | | | | | | | |
| Slip-Off Resistance (kN) | 9.57 | 10.91 | 11.29 | 11.91 | 11.04 | 12.67 | 11.10 | 11.58 |
| Slip-Off Resistance (Index) | 100 | 114 | 118 | 124 | 115 | 132 | 116 | 121 |

As shown in Table 1, it is proved that the maximum value of the resistance force of the tire having the high-hardness rubber layer in the bead inner-face part of the bead part is improved. Namely, it is proved that the rim slip-off resistance is improved. Further, it is proved that the maximum value of the resistance force is improved as the durometer A hardness of the rubber member for the high-hardness rubber layer 100 is higher and the thickness of the high-hardness rubber layer 100 is larger.

TABLE 2

| | Comparative | Example | Example | Example |
|---|---|---|---|---|
| | Example A | A1 | A2 | A3 |
| Thickness of High- | — | 12 | 8 | 5 |
| Hardness Rubber | | | | |
| Layer D10 with | | | | |
| respect to Bead Part | | | | |
| 2 (%) | | | | |
| Thickness of High- | — | 2.2 | 1.4 | 0.8 |
| Hardness Rubber | | | | |
| Layer D10 (Maximum | | | | |
| Value) (mm) | | | | |
| Length of High- | — | 45 | 45 | 45 |
| Hardness Rubber | | | | |
| Layer in Tire | | | | |
| Radial Direction (mm) | | | | |
| Durometer A Hardness | — | 95 | 95 | 95 |
| of Rubber Member for | | | | |
| High-Hardness Rubber | | | | |
| Layer (°) | | | | |
| Durometer A Hardness | 60 | 60 | 60 | 60 |
| of Rubber Member for | | | | |
| Bead Base Part (°) | | | | |
| Slip-Off Resistance | 13.01 | 15.31 | 14.99 | 14.72 |
| (kN) | | | | |
| Slip-Off Resistance | 100 | 116 | 114 | 112 |
| (Index) | | | | |

As shown in Table 2, also in the experiment using the actual tire, it is proved that the maximum value of the resistance force of the tire having the high-hardness rubber layer in the bead inner-face part of the bead part is improved. Namely, it is proved that the rim slip-off resistance is improved. Further, similar trends between the resistance force in the comparative example and the resistance force in the example are shown in the result of the experiment shown in Table 2 and the result of the numerical analysis test by means of the finite element method (FEM) shown in Table 1. Namely, it is also proved that the result of the numerical analysis test by means of the finite element method (FEM) has sufficient reliability.

### Other Embodiment

As described above, the contents of the present invention is disclosed by way of the embodiments of the present invention, however the description and the drawings forming a part of this disclosure should not be understood as limiting the present invention.

In the first embodiment, as shown in FIG. 2, the arrangement of the high-hardness rubber layer 100 in the tire radial direction D is set to cover at least the bend core inner part 211, however the arrangement of the high-hardness rubber layer 100 in the tire radial direction D may be set to cover a part (for example, one fourth, or half) of the bead core inner part 211 in the tire radial direction D.

Further, in the first embodiment, the high-hardness rubber layer 100 is arranged in a part of the bead inner-face part 21, however the high-hardness rubber layer 100 may be arranged in the whole part of the bead inner-face part 21.

From this disclosure, various substitute embodiments, examples and operation techniques shall be reveled for a person skilled in the art. Accordingly, the scope of the present invention is defined only by matters used to specify the invention according to the claim which is appropriate from the above description.

It should be noted that the present application claims priority to Japanese Patent Application No. 2014422554, filed on Jun. 13, 2014, the entire contents of which are incorporated by reference herein.

### INDUSTRIAL APPLICABILITY

The present invention provides a tire capable of improving rim slip-off resistance.

### REFERENCE SIGNS LIST

1 PNEUMATIC TIRE
2 BEAD PART
2a BEAD TOE
3 CARCASS PART
4 SIDEWALL PART
5 TREAD PART
6 BELT LAYER
8 RIM WHEEL
10 BEAD CORE
11 BEAD FILLER
21 BEAD INNER-FACE PART
22 BEAD BASE PART
23 BEAD OUTER-FACE PART
24 BEAD HEEL PART
81 SEAL PART
82 FLANGE PRAT
85 HUMP PART
100 HIGH-HARDNESS RUBBER LAYER
200 PROJECTION PART
300 REINFORCING CORD LAYER
400 HIGH-FRICTION PART

1. A tire comprising:
a bead part having a bead core; and
a carcass layer folded around the bead core in the bead part, wherein
the bead part includes:
a bead inner-face part defined as a region at an inner side of the carcass layer in a tire width direction and at an outer side of a bead toe in a tire radial direction;
a bead base part defined as a region at an inner side of the carcass layer in the tire radial direction and at an outer side of the bead toe in the tire width direction, and
a high-hardness rubber layer having hardness higher than hardness of the bead base part and provided in at least a part of the bead inner-face part.

2. The tire according to claim 1, wherein a thickness of the high-hardness rubber layer is set in a range of 5% to 25% of a width of the bead part at a center position of the bead core in the tire width direction.

3. The tire according to claim 1, wherein the high-hardness rubber layer is formed of a rubber member having the durometer A hardness in a range of 75° to 100°.

4. The tire according to claim 1, wherein a projection part projected toward an inner side in the tire width direction is formed on the high-hardness rubber layer at an inner side in the tire width direction in the bead inner-face part.

5. The tire according to claim 1, wherein a reinforcing cord layer is provided inside the bead inner-face part.

6. The tire according to claim 5, wherein the reinforcing cord layer includes a cord extended in a direction inclined against a tire circumferential direction.

7. The tire according to claim 1, wherein a high-friction part having friction coefficient against a predetermined target surface larger than friction coefficient of the bead base part against the predetermined target surface is provided on a surface of the bead inner-face part.

8. The tire according to claim 1, wherein
a mounting direction of the tire with respect to a vehicle is designated, and
the bead part is provided only at an outer side in the mounting direction with respect to the vehicle.
